(19) United States
(12) Patent Application Publication
(10) Pub. No.: US 2008/0223237 A1
(43) Pub. Date: Sep. 18, 2008

(54) IMPRINT DEVICE, STAMPER AND PATTERN TRANSFER METHOD

(76) Inventors: Takashi ANDO, Ibaraki (JP); Masahiko Ogino, Ibaraki (JP); Hideaki Kataho, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,777

(22) Filed: Jan. 25, 2008

(30) Foreign Application Priority Data
Mar. 12, 2007 (JP) 2007-061366

(51) Int. Cl. B41K 1/42; B41F 1/16

(52) U.S. Cl. 101/333; 101/492

(57) ABSTRACT

An imprint device transfers a micropattern created on a stamper onto a material to be transferred, by bringing the stamper and the material to be transferred in contact with each other and separating the stamper from the material to be transferred. The stamper has a recessed part on a portion of an outer circumferential part thereof around a surface with the micropattern. An outer diameter of the stamper is larger than that of the material to be transferred. The outer diameter of the material to be transferred is larger than that of the surface with the micropattern.

### CROSS REFERENCE TO RELATED APPLICATIONS

This application claims the benefit of Japanese Patent Application No. 2007-061366 filed on Mar. 12, 2007, the disclosure of which is incorporated herein by reference.

### BACKGROUND OF THE INVENTION

1. Field of the Invention

The present invention relates to an imprint device for transferring a finely patterned structure created on a surface of a stamper onto a surface of a material to be transferred, to the stamper, and to a pattern transfer method.

2. Description of the Related Art

Semiconductor integrated circuits have been made extremely smaller in recent years. Formation of patterns of the extremely small circuits, which may be micro-fabricated by photolithography, for example, has required a high degree of accuracy. However, the formation of the circuits with a high accuracy is approaching a limit, as a scale of the micro-fabrication has nearly reached a wavelength of an exposing source for use in the micro-fabrication. To obtain an even higher accuracy, an electron beam writing apparatus, which is a charged particle beam apparatus, has also been used instead of a photolithography apparatus.

However, in forming patterns or extremely small circuits with the electron beam writing apparatus, the more patterns are drawn with the electron beam writing apparatus, the more time it takes for exposure, because the electron beam writing apparatus does not use a one-shot exposure with an exposing source such as an i-ray and an excimer laser. Hence the more integrated the circuits become, the more time it takes for forming patterns, which results in a poor throughput.

To speed up the formation of patterns using an electron beam writing apparatus, an electron beam cell projection lithography technique has been developed, in which electron beams are irradiated en bloc on a plurality of combined masks in various shapes. Such an electron beam writing apparatus for use in the electron beam cell projection lithography technique is necessarily large-sized and high-priced, because a structure of the apparatus becomes more complicated, and a mechanism for controlling each position of the masks with a higher accuracy is required.

In forming patterns of extremely small circuits, imprint lithography has also been known, in which a stamper having a fine pattern corresponding to a desired one is stamped onto a surface of a material to be transferred. The material to be transferred may be, for example, a substrate having a resin layer thereon (To simplify descriptions, even after a pattern is transferred on a material to be transferred, the material to be transferred is still referred to as the “material to be transferred” hereinafter). The imprint lithography can transfer a microstructure on a 50 nm scale or loss onto a material to be transferred. More specifically, the resin layer (which may also be referred to as a “pattern forming layer”) includes a thin film layer formed on a substrate and a patterned layer composed of protrusions formed on the thin film layer.

The imprint lithography has also been applied to creation of a pattern of recording bits for a large capacity recording medium, and of a pattern of a semiconductor integrated circuit. For example, a mask for fabricating a large capacity recording medium substrate or a semiconductor integrated circuit substrate can be prepared by forming protrusions of a pattern forming layer using the imprint lithography. Then portions of its thin film layer that expose as recesses of the pattern forming layer, and portions of its substrate that are immediately under the portions of the thin film layer, are etched to obtain a desired substrate.

In the imprint lithography, a stamper is used for transferring a fine pattern onto a resin layer of a material to be transferred. The stamper is then pressed onto the resin layer and is separated therefrom. A technique of separating the stamper from the material to be transferred is important without damaging an edge of the material to be transferred (a substrate), a microstructure on a pattern forming layer, and the stamper.

Japanese Laid-Open Patent Application, Publication No. SHO 63-131352 discloses a technique of separating a stamper, in which a portion of a stamper or a material to be transferred is lifted up with an axial rod. Japanese Laid-Open Patent Application, Publication No. 2004-335012 discloses another separating technique, in which a portion of a stamper is adhered to by suction and is pulled up from a material to be transferred. Japanese Laid-Open Patent Application, Publication No. 2002-197731 and Japanese Laid-Open Patent Application, Publication No. 2005-166241 disclose another separating technique, in which a wedge is inserted between a stamper and a material to be transferred to make a gap, into which compressed air is fed, to thereby separate the stamper and the material to be transferred.

U.S. Pat. No. 6,870,301 discloses another separating technique, in which a wafer is vacuum-fixed onto a stage, and a surface-flat stamper is fixed to a retaining mechanism with an angle adjuster. After a pattern is transferred, the stamper is separated from the wafer by pulling the stamper at a tilted angle with respect to a surface to which the pattern is transferred, as well as by lifting up the stamper vertically.

Such separation techniques, however, have problems as below. The former four techniques have a problem that a portion of a stamper or a material to be transferred is locally loaded and is thereby distorted or destructed.

The latter technique is more advantageous than the formers in that a stamper or a material to be transferred is subjected to less external load. However, the latter technique has a problem that, as a contact area between the wafer and the stamper is closer to a surface area of tho wafer, a force to vacuum-fix the wafer becomes smaller. When a force to lift up the stamper exceeds the vacuum-fix force, the wafer is separated not from the stamper but from the stage with the stamper attached thereto.

In other words, the latter technique requires that the contact area between the wafer and the stamper is sufficiently smaller than the surface area of the wafer, because the force to vacuum-fix the wafer needs to be larger than the force to lift up the stamper. This is not suited for a commercial mass production of a large capacity recording medium substrate or other application products, which are to be mass-produced using a single and same stamper repeated times.

It is preferable, though not necessarily, that a microstructure of recording bits for a large capacity recording medium is transferred with a pressure applied on a whole surface of a material to be transferred in one shot, so as to avoid a shear in the recording bits.

The present invention has been made in an attempt to provide an imprint device capable of transferring a micropattern onto a material to be transferred with a pressure applied on a whole surface of the material to be transferred in one shot, and capable of transferring the micropattern onto a plurality of materials to be transferred using a single and same stamper repeated times, without subjecting a local load to an end of the stamper or the material to be transferred; the stamper; and a pattern transfer method.

### SUMMARY OF THE INVENTION

According to an aspect of the present invention, an imprint device is provided, in which a stamper having a surface with a micropattern formed thereon is brought into contact with a material to be transferred; the micropattern on the stamper is transferred onto a surface of the material to be transferred; and the stamper is separated from the material to be transferred. In the imprint device, the stamper has a recessed part on at least a portion of an outer circumferential part of the surface with the micropattern formed thereon. An outer diameter of the stamper is larger than that of the material to be transferred. The outer diameter of the material to be transferred is larger than that of the micropatterned surface.

According to another aspect of the present invention, a stamper is provided, which has a surface with a micropattern formed thereon; is brought in contact with the material to be transferred; transfers the micropattern onto a surface of the material to be transferred; and is separated from the material to be transferred. The stamper has a recessed part on at least a portion of an outer circumferential part of the micropatterned surface of the material to be transferred. An outer diameter of the stamper is larger than that of the material to be transferred. The outer diameter of the material to be transferred is larger than that of the micropatterned surface.

According to still another aspect of the present invention, an imprint method is provided, which includes: a contact step of bringing a stamper having a micropattern formed thereon in contact with a material to be transferred; a transfer step of transferring the micropattern on the stamper onto a surface of the material to be transferred; and a separating step of separating the stamper from the material to be transferred. The stamper has a recessed part on at least a portion of an outer circumferential part of the micropatterned surface of the material to be transferred. An outer diameter of the stamper is larger than that of the material to be transferred. The outer is diameter of the material to be transferred is larger than that of the micropatterned surface.

Other features and advantages of the present invention will become more apparent from the following detailed description of the invention, when taken in conjunction with the accompanying exemplary drawings.

### BRIEF DESCRIPTION OF THE DRAWINGS

FIG. 1 is a schematic diagram showing a relation between outer diameters of a material to be transferred, a stamper, and a micropatterned surface of the stamper according to an embodiment of the present invention.

FIG. 2A and FIG. 2B are longitudinal and horizontal cross sectional views, respectively, each showing an imprint device and retaining units of the imprint device according to the embodiment. FIG. 2A is cut along a line A-A of FIG. 2B.

FIG. 3A and FIG. 3B are longitudinal and horizontal cross sectional views, respectively, each showing an imprint device and retaining units of the imprint device according to the embodiment. FIG. 3A is cut along a line A-A of FIG. 3B.

FIG. 4A and FIG. 4B arc longitudinal and horizontal cross sectional views, respectively, each showing an imprint device and retaining units of the imprint device according to the embodiment. FIG. 4A is cut along a line A-A of FIG. 4B.

FIG. 5A and FIG. 5B are longitudinal arid horizontal cross sectional views, respectively, each showing an imprint device and retaining units of the imprint device according to the embodiment. FIG. 5A is cut along a line A-A of FIG. 5B.

FIG. 6A to FIG. 6D are schematic views for explaining steps of an imprint method of the present invention.

FIG. 7 is a schematic block diagram showing an imprint device used in a first example.

FIG. 8A and FIG. 8B are schematic block diagrams each showing an imprint device and an arrangement of openings of an air supply passage on a stage of the imprint device, used in a second example.

FIG. 9 is an electron microscope image showing a cross section of a microstructure created in a third example.

FIG. 10 is an atomic force microscope image showing a microstructure created in a fourth example.

FIG. 11A to FIG. 11D are views for explaining steps of a method of manufacturing a discrete track medium, in fifth and sixth examples.

FIG. 12A to FIG. 12E are views for explaining steps of a method of manufacturing a discrete track medium, in a seventh example.

FIG. 13A to FIG. 13E are views for explaining steps of a method of manufacturing a disk substrate for a discrete track medium, in an eighth example.

FIG. 14A to FIG. 14E are views for explaining steps of a method of manufacturing a disk substrate for a discrete track medium, in a ninth example.

FIG. 15A to FIG. 15L are views for explaining steps of a method of manufacturing a multilayer wiring substrate in a tenth example.

### DETAILED DESCRIPTION OF THE EXEMPLARY EMBODIMENT

With reference to related drawings, an embodiment of the present invention is described below in detail.

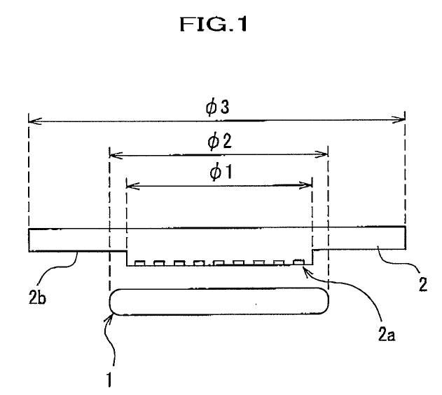

As shown in FIG. 1, outer diameters of each of a material to be transferred 1, a stamper 2, and a surface with a micropattern 2a of the stamper, which are referred to as Φ1, Φ2 and Φ3, respectively, has a relation indicated by an inequality expression as follows: Φ1<Φ2<Φ3.

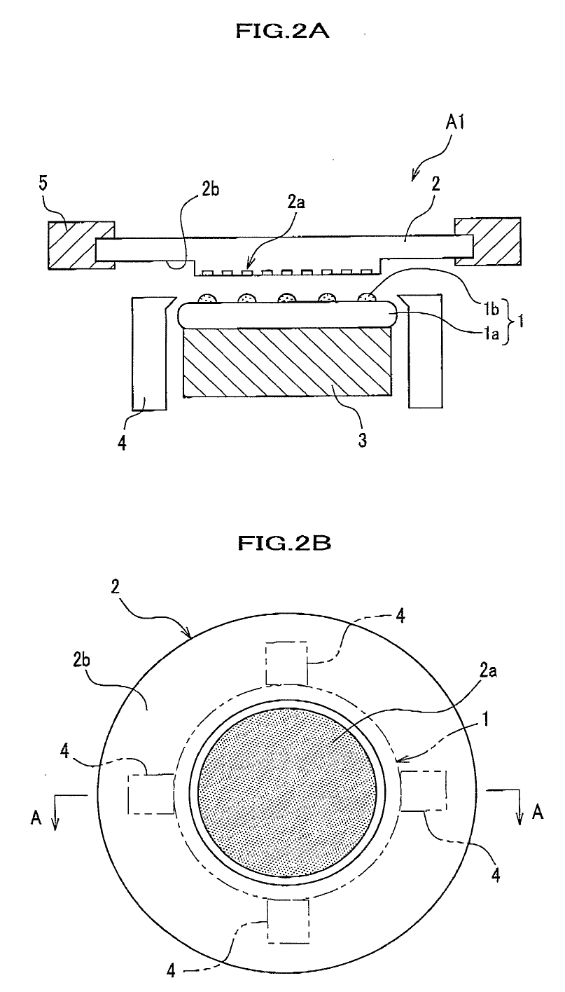

As shown in FIG. 2, an imprint device A1 includes a material to be transferred 1 on a stage 3, which is moved up and down by an up-down mechanism not shown. A stamper 2 is disposed above the material to be transferred 1. A micropattern 2a composed of protrusions is formed on a surface of the stamper 2 opposing to the material to be transferred 1. A recessed part 2b is formed on an outer circumferential part of the surface with the micropattern 2a. A stamper holder 5 holds the recessed part 2b, to thereby hold the stamper 2, too.

A plurality of retaining units 4 for retaining the material to be transferred on the stage 3 are disposed around the stage 3 and are in contact with an edge of the material to be transferred. The retaining units 4 move horizontally and vertically together with the stage 3. In the embodiment, as shown in FIG. 2B, four retaining units 4 are disposed 90 degrees apart from each other in four different directions with respect to the material to be transferred. The retaining units 4 move within an area belonging to the recessed part 2b. This allows the retaining unit 4 to move without contacting the stamper 2, and to be suitably used for different materials to be transferred 1 having various thicknesses or outer diameters.

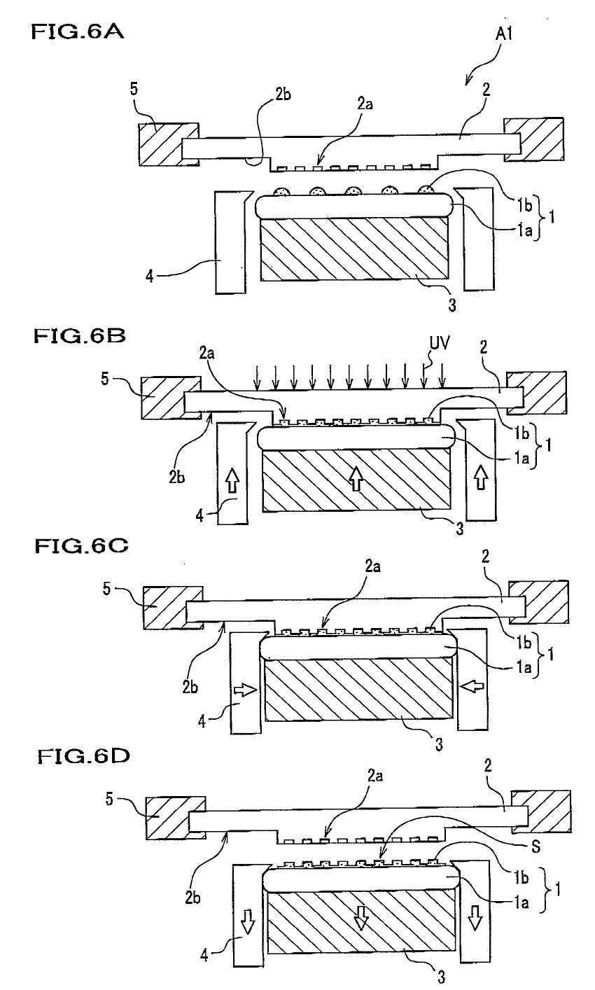

The material to be transferred 1 is a disk-shaped member, onto which the micropattern 2a formed on the stamper 2 is transferred, to be thereby created a microstructure S thereon (see FIG. 6). The material to be transferred 1 in the embodiment has a photo curable resin 1b applied on a substrate 1a thereof. The photo curable resin 1b is made into the microstructure S.

The substrate 1a may be made of silicon, glass, aluminum alloy, and resin, for example. The substrate 1a may be multilayered having a metal layer, a resin layer, an oxide film layer, or the like on its surface.

The substrate 1a of the material to be transferred 1 may have a round, oval or polygonal shape and have a hole at its center according to usage of the material to be transferred 1.

An outermost diameter of the substrate 1a may be preferably but not necessarily 20 mm or larger in consideration of a size of other components to be assembled in the imprint device A1 and an application to a large capacity recording medium substrate or a semiconductor integrated circuit substrate.

As the photo curable resin 1b, a known resin material with a photosensitive material added thereto is used. The resin material may include, as a principal component, a cycloolefin polymer, a polymethyl methacrylate, a polystyrene, a polycarbonate, a polyethylene terephthalate, a polylactic acid, a polypropylene, a polyethylene, and a polyvinyl alcohol.

The photo curable resin 1b may be applied to the substrate 1a using a dispense method or a spin-coating method.

In the dispense method, the photo curable resin 1b is applied by drops onto the substrate 1a. The dropped photo curable resin 1b spreads over a surface of the substrate 1a of the material to be transferred 1, when the stamper 2 comes in contact with the substrate 1a, If the photo curable resin 1b is dropped in different positions on the substrate 1a, it is preferable but not necessarily that each distance between centers of the drops is larger than each diameter of the drops.

A position to drop the photo curable resin 1b may be determined by an estimated spread of the photo curable resin 1b, which corresponds to a size of the micropattern 2a to be formed. A quantity of the photo curable resin 1b may be equivalent to or more than a quantity of a resin necessary for forming the microstructure S (see FIG. 6), and may be adjusted by changing a quantity of a drop of the photo curable resin 1b and its position to be dropped.

In the spin-coating method, the quantity of the photo curable resin 1b may also be equivalent to or more than a quantity of a resin necessary for forming the microstructure S (see FIG. 6), and may be adjusted by changing a spin rotation rate or a viscosity of the photo curable resin 1b.

In the embodiment, the material to be transferred 1 is prepared by applying the photo curable resin 1b to the substrate 1a. Another material to be transferred 1 may also be used in the present invention. For example, the material to be transferred 1 may be prepared by forming a thin film made of a thermosetting resin, a thermoplastic resin, or any other resin on a substrate. The material to be transferred 1 may be a substrate made of only a resin (including a rosin sheet).

If the material to be transferred 1 containing a thermoplastic resin material is used, the material to be transferred 1 is pressed on the stamper 2, and then, the stamper 2 and the material to be transferred 1 are cooled to cure the thermoplastic resin material. If the material to be transferred 1 containing a thermosetting resin material is used, the material to be transferred 1 is pressed on the stamper 2, and then, the stamper 2 and the material to be transferred 1 are maintained at or higher than a polymerization temperature of the resin material to cure the thermosetting resin material. After that, in both cases, the stamper 2 and the material to be transferred 1 are separated from each other, to thereby obtain the material to be transferred 1 having the microstructure S (see FIG. 6) transferred from the stamper 2 on its surface.

The micropattern 2a composed of projections may be formed on a surface of the stamper 2 using photolithography, focused ion beam lithography, electron beam writing, and plating, one of which may be selected according to a processing accuracy required for the micropattern 2a to be created.

The stamper 2 used in the embodiment is made of a transparent material, because irradiation of ultraviolet rays has to reach and cure the material to be transferred 1 (the photo curable resin 1b applied on the substrate 1a) across the stamper 2. The transparent material may be silicon or glass. If a thermosetting resin or a thermoplastic resin is used, instead of the photo curable resin 1b, the stamper 2 may be made of an opaque material such as silicon, nickel and resin.

The stamper 2 may have a round, oval or polygonal shape and have a hole at its center according to how the stamper 2 is pressed onto the material to be transferred 1. A release agent based on fluorine, silicone, or the like may be applied to the surface of the stamper 2 so as to facilitate separation between the material to be transferred 1 (the photo curable resin 1b) and a material provided thereon.

The recessed part 2b is provided around an outer circumference of the micropattern 2a of the stamper 2, and may be formed by cutting or milling the stamper 2 or by sticking two substrates having different outer diameters together.

The retaining units 4 are provided around the stage 3 and is in contact with only an end (for example, a chamfered portion or a lateral side) of the material to be transferred 1, without coming in contact with the stamper 2 and the surface with the micropattern 2a. Surfaces of the retaining units 4 which are in contact with the material to be transferred 1 may have any shape, and may be made of any material as long as the surfaces do not damage the material to be transferred 1. The material of the surfaces may be metal, resin and glass, for example.

The retaining units 4 retain the material to be transferred 1 without coming into contact with the stamper 2 and the micropattern 2a. As shown in FIG. 1, it is preferable but not necessary that an outer diameter (Φ1) of the surface with the micropattern 2a is smaller than that (Φ2) of the stamper 2, and that a difference therebetween is within a range from 0.1 mm to 10 mm.

The retaining units 4 may be provided at least in two directions as seen from a center of the material to be transferred 1, because the retaining units 4 are required to retain the material to be transferred 1 and the stamper 2, only when the material to be transferred 1 and the stamper 2 are separated from each other. In this case, the recessed part 2b formed around the micropattern 2a is formed within an area where the retaining units 4 are disposed or moved, in other words, on a portion of an outer circumferential part of the surface with the micropattern 2a.

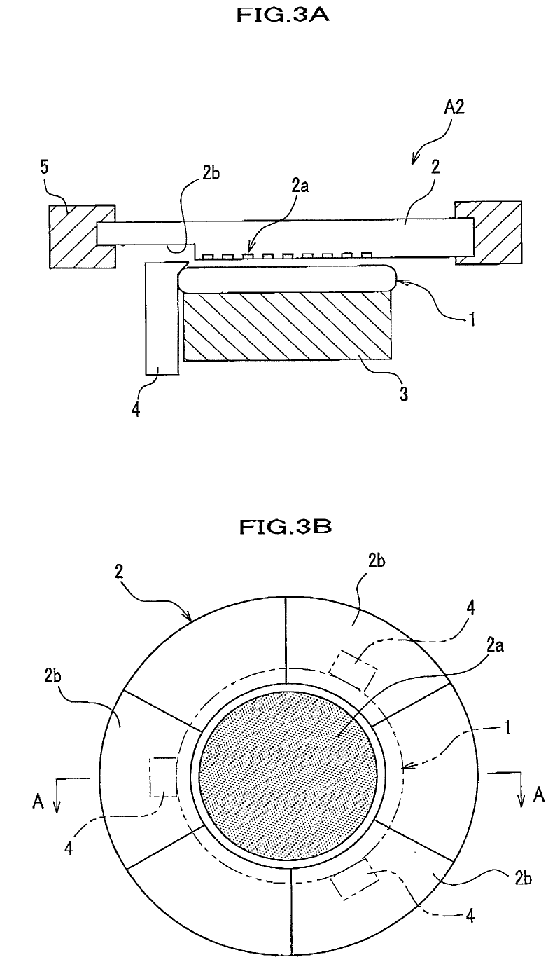

As shown in FIG. 3, if three retaining units 4 are separately provided 120 degrees apart in three directions as seen from the center of the material to be transferred 1, three recessed parts 2b may be formed in three portions around the outer circumference of the surface with the micropattern 2a, at respective positions corresponding to the three directions.

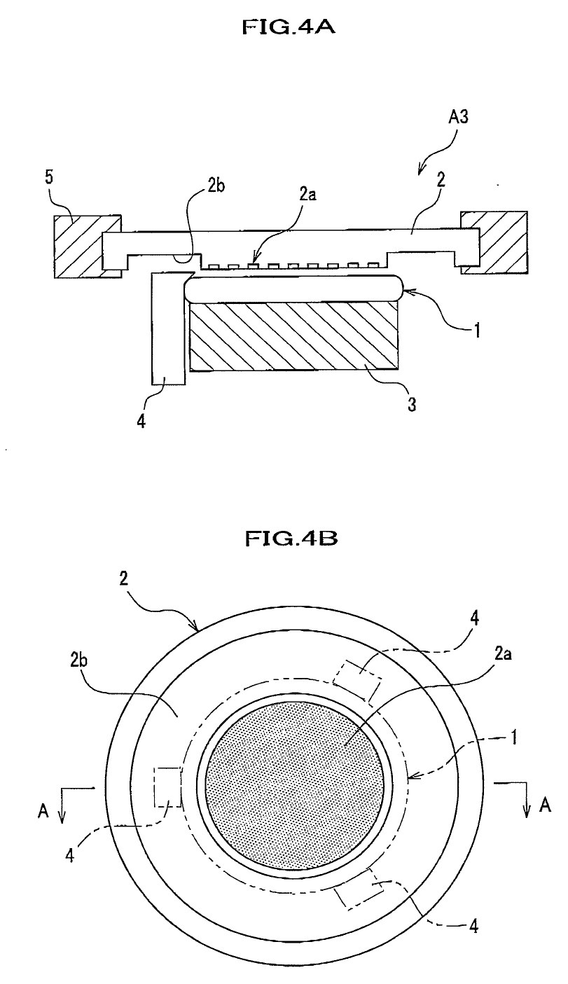

As shown in FIG. 4A and FIG. 4B, the three recessed parts 2b may be formed only within an area in which the retaining units 4 move with respect to a horizontal direction. In this case, the recessed parts 2b are formed around the surface with the micropattern 2a, other than an outer circumference end part of the stamper 2. In FIG. 4A and FIG. 4B, the retaining units 4 are formed in the three directions. However, the present invention is not limited to this. The retaining units 4 may be formed in two directions or four directions or more.

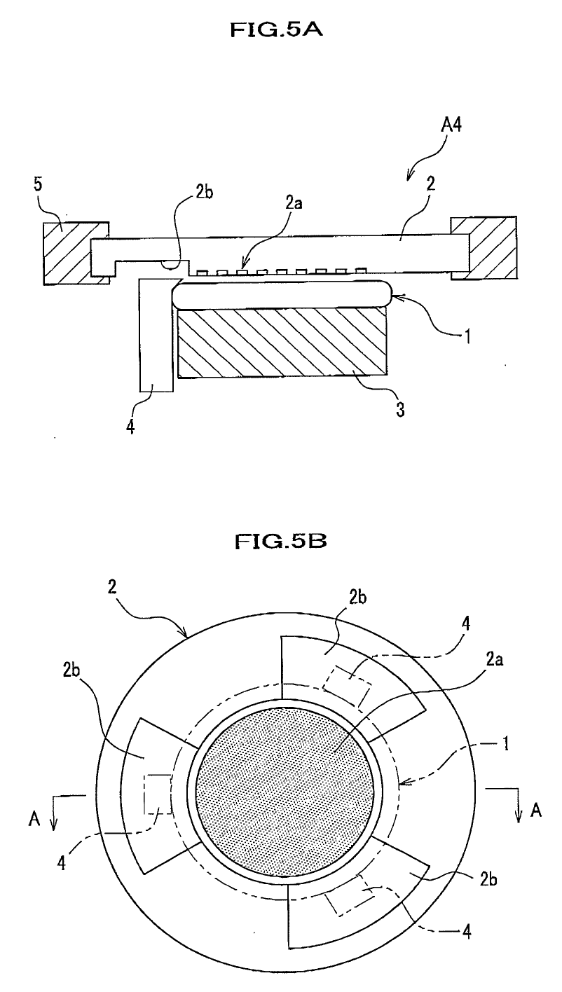

As shown in FIG. 5A and FIG. 5B, three recessed parts 2b may be separately provided around the surface with the micropattern 2a but only in fan-shaped areas surrounding the respective retaining units 4 in which the retaining units 4 move in horizontal directions with respect to the respective retaining units 4.

In the imprint devices A2,A3,A4 shown in FIG. 3, FIG. 4, and FIG. 5, respectively, each configuration of the material to be transferred 1, stage 3, and stamper holder 5 is the same as that in the imprint device A1 shown in FIG. 1, description of which is omitted herefrom.

Next is described the imprint method according to the embodiment with reference to related drawings, by describing operations performed by the imprint device A1. FIG. 6A to FIG. 6D are cross sectional views for explaining steps of the imprint method.

In FIG. 6A, the photo curable resin 1b is applied in advance to a surface (opposing to the stamper 2) of the substrate 1a of the material to be transferred 1. The material to be transferred is disposed on the stage 3. The stamper holder 5 holds the stamper 2, on which the micropattern 2a is formed in advance.

In FIG. 6B, the up-down mechanism not shown lifts up the stage 3 to press the material to be transferred 1 onto the stamper 2. The photo curable resin 1b thus spreads over a surface of the substrate 1a and the micropattern 2a. Then ultraviolet rays are irradiated on the photo curable resin 6 across the stamper 2, thus curing the photo curable resin 6.

In FIG. 6C, the retaining units 4 retain an outer circumference end of the material to be transferred 1. The retaining units 4 move in horizontal and vertical directions within an area belonging to the recessed part without contacting the stamper 2 or the surface with the micropattern 2a.

In FIG. 6D, the up-down mechanism not shown lowers the stage 3 and the retaining units 4 together, to thereby separate the material to be transferred 1 from the stamper 2.

With the steps described above, the microstructure S corresponding to the micropattern 2a of the stamper 2 is formed on the surface (the photo curable resin 1b) of the material to be transferred 1.

The material to be transferred 1 with the microstructure S formed thereon can be applied to an information recording medium such as a magnetic recording medium, an optical recording medium, or the like. The material to be transferred 1 can also be applied to a large-scale integrated circuit component; an optical component such as a lens, a polarizing plate, a wavelength filter, a light emitting device, and an integrated optical circuit; and a biodevice for use in an immune assay, a DNA separation, and a cell culture.

As described above and shown in FIG. 1, in the imprint device A1, the stamper 2 has the recessed part 2b around the outer circumference of the micropattern 2a. The outer diameter Φ3 of the stamper 2 is larger than the outer diameter Φ2 of the material to be transferred 1. The outer diameter Φ2 of the material to be transferred 2 is larger than the outer diameter Φ1 of the surface with the micropattern 2a. That is, the outer diameters Φ1,Φ2,Φ3 has a relation indicated by an inequality expression as follows:

Φ1<Φ2<Φ3

The relation between the outer diameters Φ1,Φ2,Φ3 allows the retaining units 4 to retain the outer circumference end of the material to be transferred 1 without contacting the stamper 2 and the micropattern 2a. Further, the retaining units 4 are lowered together with the stage 3 to separate the material to be transferred 1 from the stamper 2, without subjecting a local load to an end of the stamper 2 or the material to be transferred 1. The separation is successfully conducted, even if a contact area between the material to be transferred 1 and the stamper 2 (the micropattern 2a) is about the same as a surface area of the material to be transferred 1.

In the imprint device 1, the stamper 2, and the imprint method according to the embodiment, the micropattern 2a of the stamper 2 can be transferred onto an entire surface of the material to be transferred with a pressure applied in one shot; an end of the stamper 2 or the material to be transferred 1 is not damaged; and the micropattern 2a can be transferred on a plurality of the materials to be transferred 1 using a single and same stamper 2 repeated times.

### EXAMPLES

More detailed and specific descriptions are provided on the present invention by presenting various examples as follows.

### Example 1

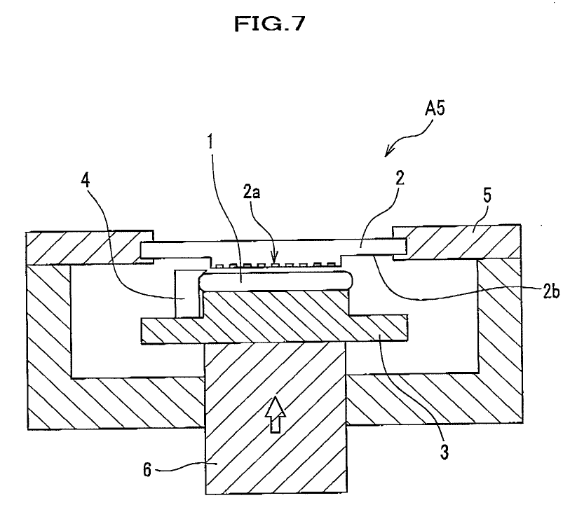

Example 1 describes an imprint method, in which the micropattern 2a of the stamper 2 is transferred onto the material to be transferred 1 using an imprint device A5 shown in FIG. 7.

As shown in FIG. 7, in the imprint device A5, the material to be transferred 1 is disposed on the stage 3 made of stainless and vertically moved by an up-down mechanism 6, across a buffer layer, not shown. The buffer layer is made of silicone rubber 0.5 mm in thickness. The material to be transferred 1 is disposed such that its surface with a resin applied thereon opposes to a surface with the micropattern 2a of the stamper 2. In FIG. 7, only one of the retaining units 4 is shown. However, three retaining units 4 are disposed in three directions as seen from a center of the material to be transferred 1, as shown in FIG. 3 to FIG. 5. A space surrounding the stage 3 can be used as a decompression chamber, when air is exhausted from the space with a vacuum pump (not shown) or the like.

As the material to be transferred 1, a glass substrate for a magnetic recording medium was used, which had a diameter of 65 mm, a thickness of 0.631 mm, and a center through hole with a diameter of 20 mm. Inner and outer circumferential ends of the material to be transferred 1 were chamfered each by a width of 0.15 mm and an angle of 45 degrees.

As the stamper 2, a quartz substrate was used, which had an outermost diameter of 100 mm and a thickness of 3 mm. A plurality of concentric grooves were created as the micropattern 2a in an area from 23 mm to 63 mm in diameter from a center of the stamper 2 using photolithography. Each of the grooves had a width of 2 μm, a pitch of 4 μm, and a depth of 80 μm. A central axis of a pattern constituted by the grooves was agreed with that of a central axis of the center hole. The recessed part 2b having a depth of 0.5 mm was formed around the surface with the micropattern 2a, by cutting an area from 64 mm to 100 mm in diameter from the center of the stamper 2 and 0.5 mm in depth. A release layer containing fluorine was formed on a surface (opposing to the material to be transferred 1) of the stamper 2.

A resin not shown was applied by drops onto a surface (opposing to the stamper 2) of the material to be transferred 1 (the glass substrate for a magnetic recording medium, using the disperse method. More specifically, the resin was applied by an application head, in which 512 nozzles (256 nozzles×2 rows) were arranged to discharge the resin using a piezo method.

A distance between the nozzles was 70 μm in a row direction thereof arid a distance between the two rows was 140 μm. Each of the nozzles discharged the resin of about 5 pL.

The resin used in this Example was an acrylate resin with a photosensitive substance added thereto, and was prepared to have a viscosity of 4 mPa·s.

A position on the surface of the material to be transferred 1 from which the resin was discharged was determined according to an estimated spread of a drop of the resin. The estimated spread was obtained from a result of applying pressure to the stamper 2 and the material to be transferred 1 were against each other. More specifically, when the stamper 2 and the material to be transferred 1 were applied pressure against each other, a drop of the resin spread in an oval shape with a larger diameter of about 140 μm in a vertical direction to the pattern of the grooves of the micropattern 2a (that is, in a radial direction of the material to be transferred 1) and with a smaller diameter of about 850 μm in a parallel direction to the pattern (that is, in a circumferential direction to the material to be transferred 1). Thus, the resin was determined to be applied by drops each having a diameter in the radial direction of 80 μm and in the circumferential direction of 510 μm, onto an area within a diameter from 20 mm to 25 mm of the material to be transferred 1.

Three retaining units 4 were separately provided 120 degrees apart in three directions as seen from a center of the material to be transferred 1. Each of the retaining units 4 were formed to come in contact with respective contact parts of the material to be transferred 1 (see FIG. 3B). Each of the contact parts retained one sixth of the whole outer circumferential part of the material to be transferred 1. An inner end nearer to the material to be transferred 1 of each of the retaining units 4 were formed in a hook shape having 0.3 mm in length. The inner ends hooked to the chamfered portions on the outer circumferential end of the material to be transferred 1. A part of the retaining units 4 to which the material to be transferred 1 came in contact were made of polyether ether ketone from a viewpoint of moldability and durability. The retaining units 4 were movable in the horizontal direction within an area from 65 mm to 75 mm from a central axis of the material to be transferred 1. The retaining units 4 were also movable in an outer circumferential direction thereof, when the material to be transferred 1 was put on or removed from the stage 3.

Next is described an imprint method using the imprint device A5.

The material to be transferred 1 was disposed on the stage 3. A vacuum pump (not shown) decompressed an atmosphere around surfaces of the material to be transferred 1 and the stamper 2. The up-down mechanism 6 lifts up the stage 3 to apply pressure to the material to be transferred 1 and the stamper 2. A load of the pressure was set at 1 kN. When the material to be transferred 1 and the stamper 2 were subjected to the pressure, a light source (not shown) disposed above the stamper 2 (a surface thereof not having the micropattern 2a) radiated ultraviolet rays onto the resin through the stamper 2, thus curing tho resin. After the resin was cured, the retaining units 4 retained the material to be transferred 1 and the up-down mechanism 6 lowered the stage 3, to thereby separate the material to be transferred 1 from the stamper 2. Then the retaining units 4 were moved away from the material to be transferred 1 in the outer circumference direction of the material to be transferred 1. This allowed the material to be transferred 1 to be taken out of the imprint device A5. The obtained material to be transferred 1 had the pattern of grooves (a microstructure) corresponding to the micropattern 2a formed on the surface of the stamper 2. Each of the grooves had a width of 2 μm, a pitch of 4 μm, and a depth of 80 nm.

It is to be noted that the material to be transferred 1 and stamper 2 came in contact under the depressed atmosphere in this Example. However, the present invention is not limited to this. The material to be transferred 1 and stamper 2 may come in contact under a normal atmosphere.

### Example 2

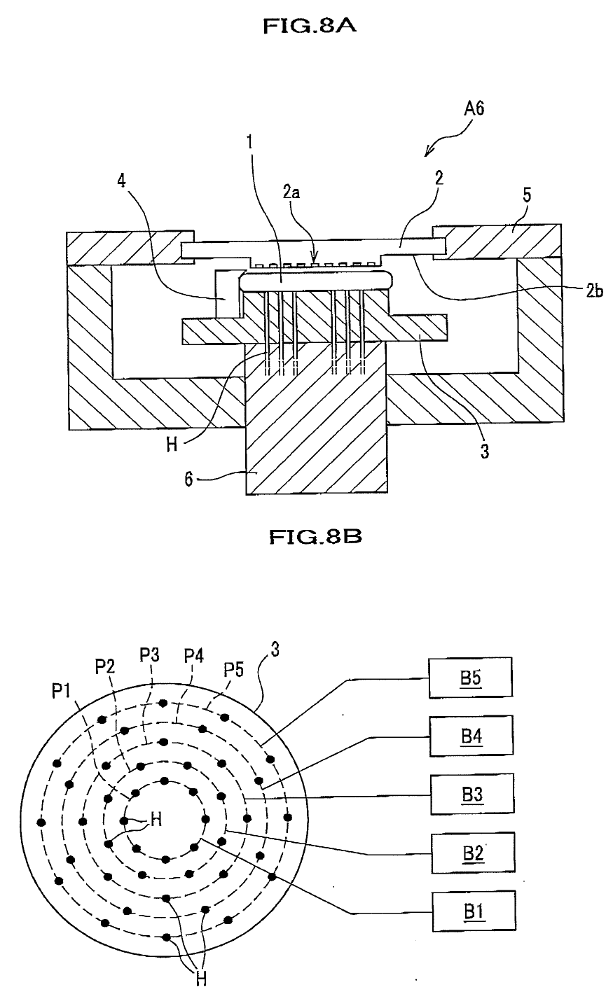

Example 2 describes an imprint method using an imprint device A6 shown in FIG. 8, in which the micropattern 2a of the stamper 2 is transferred onto the material to be transferred 1. FIG. 8A and FIG. 8B are schematic block diagrams each showing the imprint device 6A and an arrangement of openings of an air supply passage on the stage 3.

A configuration of Example 2 is the same as that of example 1 except that the imprint device A6 used in Example 2 has a different structure of the stage 3 and uses a different way of application of pressure. In Example 2, the differences from Example 1 are mainly described.

As shown in FIG. 8A, the imprint device A6 has a plurality of passages H on a top surface of the stage 3, through which pressurized fluid flows. Each of the passages H penetrates the up-down mechanism 6 and the stage 3 and opens on the top surface of the stage 3.

As shown in FIG. 8B, the openings of the passages H on the top surface of the stage 3 are arranged on five concentric circles. The passages H arranged on the same concentric circle are connected to a same pipe. More specifically, the passages H arranged on an innermost concentric circle on the stage 3 are connected to a circular pipe P1; the passages arranged on a second innermost concentric circle, to a circular pipe P2; on a third, a pipe P3; on a fourth, a pipe P4; and on a fifth, a pipe P5. The pipes P1 to P5 are disposed inside the up-down mechanism 6. The pipes P1 to P5 are respectively connected to pressure regulation mechanisms B1 to B5 each for regulating pressure of fluid flowing in the pipes P1 Lo P5. The pressure regulation mechanisms B1 to B5 regulate the pressure of the fluid such that the fluid discharged from the passages H on a same concentric circle at a same pressure.

Next is described the imprint method using the imprint device A6, by describing operations thereof. In the present Example, the same material to be transferred 1 and the same stamper 2 were used as those in Example 1.

The material to be transferred 1 was disposed on the stage 3. Fluid was discharged from the openings of the passages H, to thereby lift up a lower surface of the material to be transferred 1 from the top surface of the stage 3. This brought a top surface of the material to be transferred 2 in contact with the stamper 2. Pressure of the fluid discharged is regulated such that a pressure from the innermost pipe P1 was highest, and the pressures from the pipes P2 to P5 were lowered by stages, with that from the pipe P5 the lowest. The material to be transferred 1 is thus subjected to apply the highest pressure at a center part of the top surface thereof to press the material to be transferred 1, and to loss pressure as farther away from the center. Application of such a pressure distribution suitably spread the resin not shown between the material to be transferred 1 and the stamper 2.

After the resin was cured as in Example 1, discharge of the fluid from the pipes P1 to P5 was stopped, and the material to be transferred 1 was separated from the stamper 2 as in Example 1. The obtained material to be transferred 1 had the pattern of grooves (a microstructure) corresponding to the micropattern 2a formed on the surface of the stamper 2. Each of the grooves had a width of 2 μm, a pitch of 4 μm, and a depth of 80 nm.

In the imprint methods in Examples 1 and 2 using the imprint devices A5 and A6, respectively, the material to be transferred 1 can be separated from the stamper 2 without subjecting a local load on the surfaces thereof and without damaging the microstructure or the surface with the micropattern 2a. Further, the material to be transferred 1 can be successfully separated from the stamper 2, even if an area with the microstructure of the material to be transferred 1 is about the same as a surface area of the material to be transferred 1.

### Example 3

Example 3 describes a material with transferred thereon a micropattern for a large capacity magnetic recording medium (a discrete track medium). The material was manufactured by using the imprint device A6 (see FIG. 8) in Example 2. A material to be transferred used herein is the same as the material to be transferred 1 used in Example 1.

As the stamper 2, two quartz substrates were prepared. One of which had a diameter of 64 mm and a thickness of 0.5 mm, and the other had a diameter of 100 mm and a thickness of 1.5 mm, which were bonded together by an ultraviolet cure adhesive. A plurality of concentric grooves were created on the former quartz substrate having the diameter of 64 mm and the thickness of 0.5 mm, using a known direct electron beam writing method. Each of the grooves had a width of 50 nm, a depth of 80 nm, and a pitch of 100 nm. A central axis of the concentric grooves was agreed with that of the material to be transferred 1.

A resin was applied by drops onto a surface of a glass disk substrate using the dispense method. More specifically, the resin was applied by an application head, in which 512 nozzles (256 nozzles×2 rows) were arranged to discharge the resin using the piezo method. A distance between the nozzles was 70 μm in a row direction thereof and a distance between the two rows was 140 μm. Each of the nozzles discharged the resin of about 5 pL. The resin was applied by drops each having a diameter in the radial direction of 150 μm and in the circumferential direction of 270 μm.

The resin used in the present Example was an acrylate resin with a photosensitive substance added thereto, and was prepared to have a viscosity of 4 mPa·s.

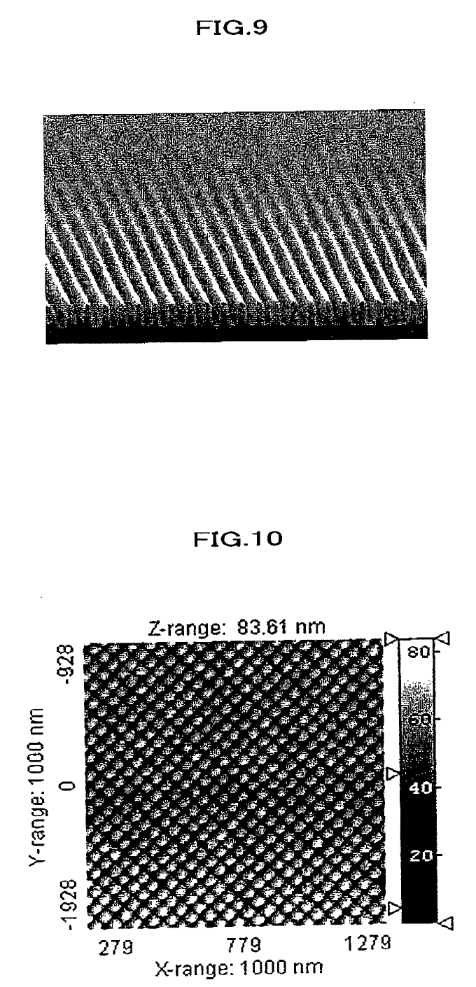

Using the imprint method same as that in Example 2, the material to be transferred 1 on which a pattern of grooves (a microstructure) corresponding to the micropattern 2a formed on a surface of the stamper 2 was transferred was obtained. Each of the grooves had a width of 50 nm, a depth of 80 nm, and a pitch of 100 nm. FIG. 9 is an electron microscope image showing a cross section of the microstructure created in this Example.

### Example 4

Example 4 describes a material with a micropattern transferred thereon for a large capacity recording medium (a patterned medium). The material was manufactured by using the imprint method same as that in Example 3. A material to be transferred used herein is the same as the material to be transferred 1 used in Example 1.

As the stamper 2, two quartz substrates were prepared each having a size same as that used in Example 3, which were also bonded together. A plurality of holes were concentrically created on one of the quartz substrate having the diameter of 64 mm and the thickness of 0.5 mm, using a known direct electron beam writing method. Each of the holes had a width of 25 nm, a depth of 60 nm, and a pitch of 45 nm. A central axis of the concentrically arranged holes was agreed with that of the central hole of the material to be transferred 1.

Using the imprint method same as that in Example 3, the material to be transferred 1 on which a micropattern, a pattern of the concentrically arranged holes (a microstructure) corresponding to the micropattern 2a formed on a surface of the stamper 2, was transferred was obtained. Each of the grooves bad a diameter of 25 nm, a length of 60 nm, and a pitch of 45 nm. FIG. 10 is an atomic force microscope image showing the microstructure created in the present Example.

### Example 5

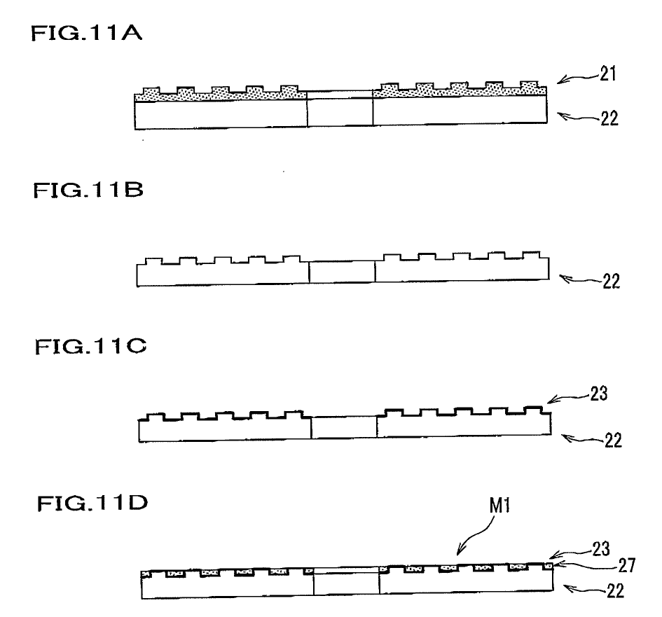

Example 5 describes a method of manufacturing a discrete track medium using the imprint method of the present invention with reference to related drawings. FIG. 11A to FIG. 11D are views for explaining steps of the method of manufacturing a discrete track medium.

In FIG. 11A, a glass substrate 22 having thereon a pattern formation layer 21 made of the light curable resin 6 on which a micropattern on the stamper 2 had been transferred, as that obtained in Example 3, was provided.

A surface of the glass substrate 22 was dry-etched with a known dry etching method, utilizing the pattern formation layer 21 as a mask. In FIG. 11B, a microstructure corresponding to the micropattern on the pattern formation layer 21 was etched on the surface of the glass substrate 22. The dry etching was performed with fluorine-based gas. Alternatively, the dry etching may be performed in such a way that a thin layer portion of the pattern formation layer 21 is removed using the oxygen plasma etching, and an exposed portion of the glass substrate 22 is etched with fluorine-based gas.

In FIG. 11C, a magnetic recording medium forming layer 23 was formed on the glass substrate 22 with the microstructure formed thereon, using a known DC magnetron sputtering method. The magnetic recording medium forming layer 23 included a precoat layer, a magnetic domain control layer, a soft magnetic foundation layer, an intermediate layer, a vertical recording layer, and a protective layer. The magnetic domain control layer in this Example further included a nonmagnetic layer and an antiferromagnetic layer.

In FIG. 11D, a nonmagnetic material 27 was applied onto the magnetic recording medium forming layer 23, to thereby make the surface of the glass substrate 22 flat. With the steps described above, a discrete track medium M1 having a surface recording density of about 200 Gbpsi was obtained.

### Example 6

Example 6 describes a method of manufacturing a patterned medium using the imprint method same as that of Example 5 (see FIG. 11). The imprint method same as that of Example 5 also included a step of dry-etching a surface of tho glass substrate 22 and a step of forming the magnetic recording medium forming layer 23. With the steps described above, a patterned medium having a surface recording density of about 300 Gbpsi was obtained.

### Example 7

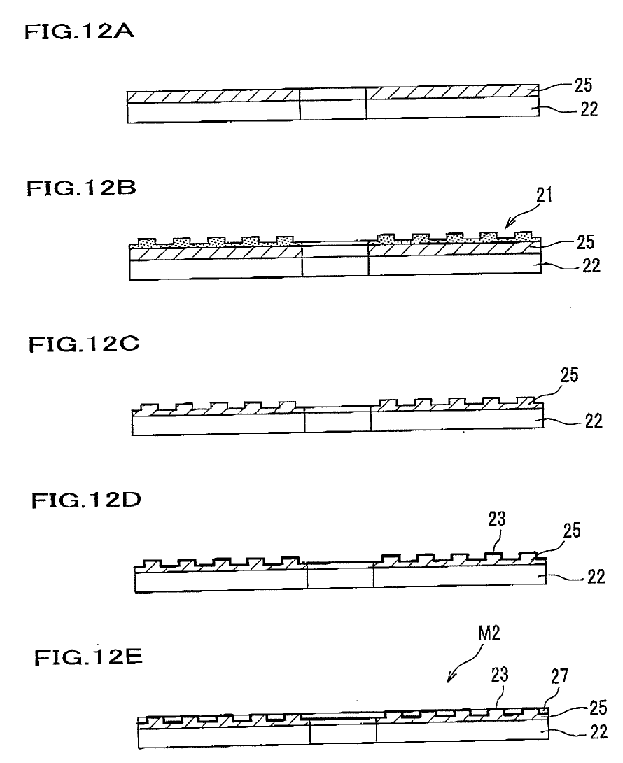

Example 7 describes a method of manufacturing another discrete track medium using the imprint method of the present invention with reference to FIG. 12A to FIG. 12E, which are views for explaining steps of the method of manufacturing another discrete track medium.

In FIG. 12A, the glass substrate 22 having the soft magnetic foundation layer 25 thereon was used, instead of the glass substrate 22 having the pattern formation layer 21 thereon, which was obtained in Example 3. In FIG. 12B, the pattern formation layer 21 made of the light curable resin 6 was formed on the glass substrate 22 having the soft magnetic foundation layer 25 thereon. The pattern formation layer 21 had a micropattern transferred from the stamper 2, using the imprint device A6 (see FIG. 8).

A surface of the soft magnetic foundation layer 25 was dry-etched with a known dry etching method, utilizing the pattern formation layer 21 as a mask. In FIG. 12C, the dry etching created a microstructure corresponding to the micropattern of the pattern formation layer 21, on the surface of the soft magnetic foundation layer 25. Herein the dry etching was performed with fluorine-based gas.

In FIG. 12D, the magnetic recording medium forming layer 23 was formed on the soft magnetic foundation layer 25, on which the microstructure had been created, using a known DC magnetron sputtering method. The magnetic recording medium forming layer 23 included a precoat layer, a magnetic domain control layer, another soft magnetic foundation layer, an intermediate layer, a vertical recording layer, and a protective layer. The magnetic domain control layer in this Example further included a nonmagnetic layer and an antiferromagnetic layer.

In FIG. 12E, a nonmagnetic material 27 was applied onto the magnetic recording medium forming layer 23, to thereby make a top surface of the soft magnetic foundation layer 25 flat. With the steps described above, a discrete track medium M2 having a surface recording density of about 200 Gbpsi was obtained.

### Example 8

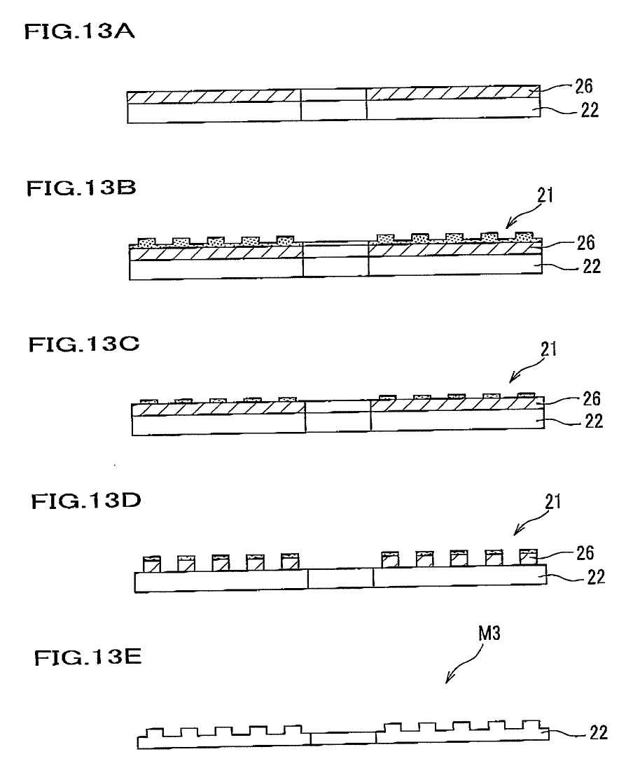

Example 8 describes a method of manufacturing a disk substrate for a discrete track medium using the imprint method of the present invention with reference to FIG. 13A to FIG. 13E, which are views for explaining steps of the method of manufacturing a disk substrate for a discrete track medium.

In FIG. 13A, a novolac resin material was applied in advance to a surface of the glass substrate 22 to form a flat layer 26. The flat layer 26 may be formed by the spin coat method or by pressing the novolac resin material to the surface of the glass substrate 22 using a flat plate. In FIG. 13B, the pattern formation layer 21 was formed on the flat layer 26 by applying a resin material containing silicon onto the flat layer 26 and using the imprint method of the present invention.

In FIG. 13C, a thin layer portion of the pattern formation layer 21 was removed with a known dry etching method using fluorine-based gas. In FIG. 13D, the flat layer 26 was removed with the oxygen plasma etching, using a not-yet-removed portion of the pattern formation layer 21 as a mask. In FIG. 13E, the glass substrate 22 was etched using the dry etching method. With the steps described above, a disk substrate M3 used as a discrete track medium having a surface recording density of about 200 Gbpsi was obtained.

### Example 9

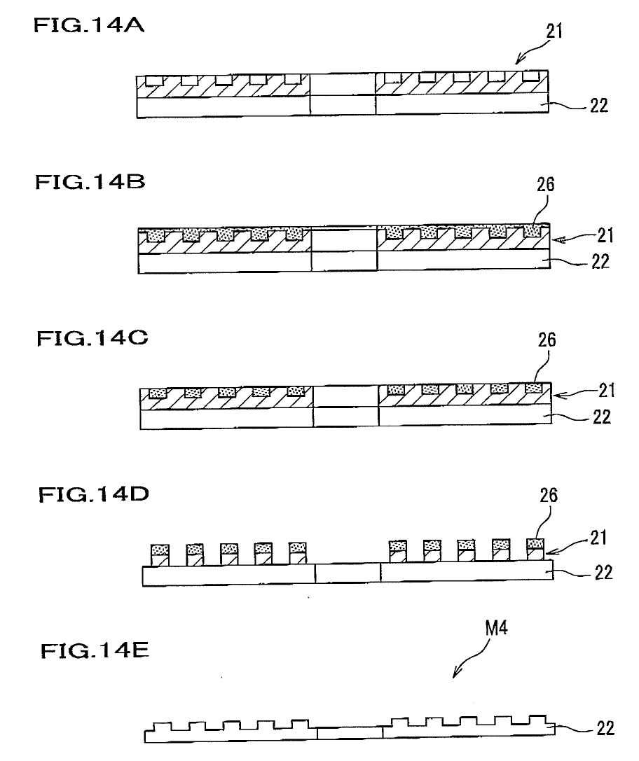

Example 9 describes a method of manufacturing another disk substrate for a discrete track medium using the imprint method of the present invention with reference to FIG. 14A through FIG. 14E, which are views for explaining steps of the method of manufacturing another disk substrate for a discrete track medium.

In FIG. 14A, the pattern formation layer 21 was formed on the glass substrate 22, by applying an acrylate resin material with a photosensitive substance added thereto, to a surface of the glass substrate 22, and by using the imprint method of the present invention. In this Example, the pattern formation layer 21 was formed to have a microstructure complementary to a desired one. In FIG. 14B, a resin material containing silicon and a photosensitive substance was applied to a surface of the pattern formation layer 21 to form the flat layer 26. The flat layer 21 may be formed by the spin coat method or by pressing the resin onto the surface of the glass substrate 22 using a flat plate.

In FIG. 14C, a surface of the flat layer 26 was etched using fluorine-based gas to remove a thin layer portion of the pattern formation layer 21. In FIG. 14D, the pattern formation layer 21 was removed with the oxygen plasma etching method using a not-yet-removed portion of the flat layer 26 as a mask, thus exposing a portion of the surface of the glass substrate 22. In FIG. 14E, the exposed portion of the glass substrate 22 was etched using fluorine-based gas. With the steps described above, a disk substrate M4 used as a discrete track medium having a surface recording density of about 200 Gbpsi was obtained.

### Example 10

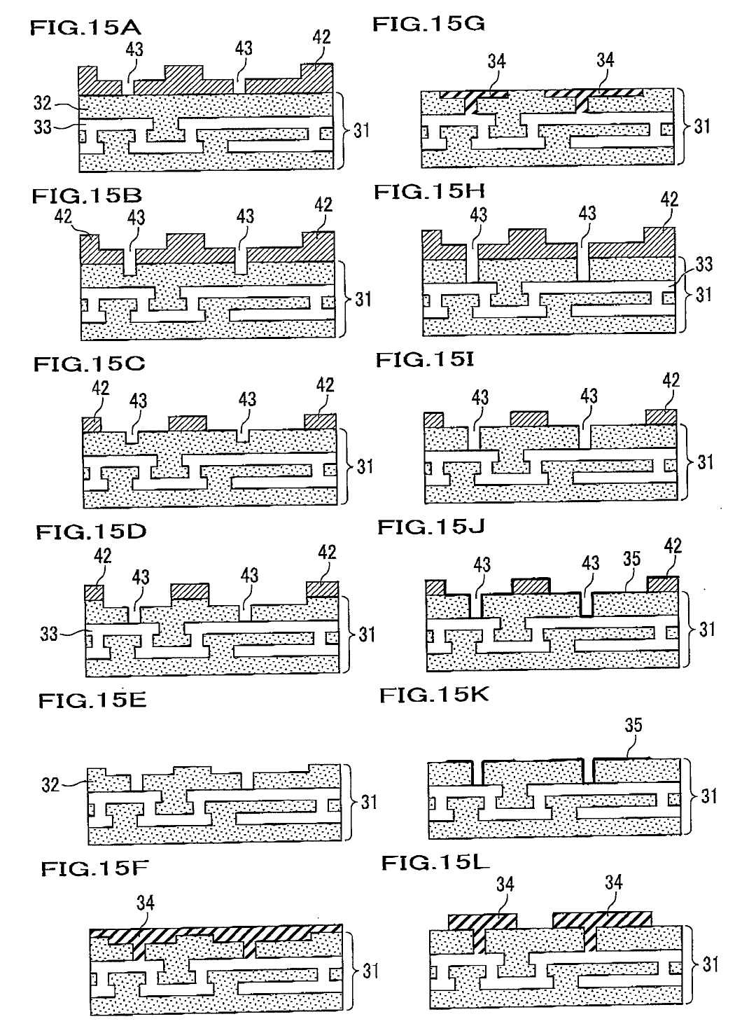

Example 10 describes a method of manufacturing a multilayer wiring substrate using the imprint method of the present invention with reference to FIG. 15A to FIG. 15L, which are views for explaining stops of the method of manufacturing the multilayer wiring substrate.

In FIG. 15A, the stamper 2 (not shown) and a multilayer wiring substrate 31 were aligned to a desired position, and a wiring pattern formed on the stamper 2 was transferred on the substrate 31 composed of a silicon dioxide film 32 and a copper wiring 33. Then a micropattern composed of resists 42 and groove-like exposed portions 43 were formed on a surface of the substrate 31.

In FIG. 15B, the exposed portions 43 on the surface of the multilayer wiring substrate 31 were dry-etched with CF₄/H₂ gas to groove down the substrate 31. In FIG. 15C, the resists 42 were resist-etched using RIE, until lower portions of the resists 42 were removed up to the surface of the substrate 31, thus extending the exposed portions 43 surrounding the resists 42 on the substrate 31. In FIG, 15D, the extended exposed portions 43 were further dry-etched until the exposed portions 43 were grooved down to finally reach the copper wiring 33.

In FIG. 15E, the resists 42 were removed to obtain the multilayer wiring substrate 31 having grooves on its surface. A metal film (not shown) was formed on the surface of the multilayer wiring substrate 31, to which was further applied electrolytic plating. In FIG. 15F, the multilayer wiring substrate 31 had a metal plating film 34 formed thereon. The 1o metal plating film 34 was ground until the silicon dioxide film 32 was exposed. As a result, in FIG. 15G, the multilayer wiring substrate 31 having a metal wiring composed of the metal plating film 34 on its surface was obtained.

Another method of manufacturing the multilayer wiring substrate 31 is described below with reference to FIG. 15A and FIG. 15H through FIG. 15L, which are views for explaining steps of the method of manufacturing the multilayer wiring substrate 31.

As shown in FIG. 15A, the multilayer wiring substrate 31 same as that provided in the above-mentioned steps was prepared. In FIG. 15H, the multilayer wiring substrate 31 was dry-etched until the exposed portions 43 reached the copper wiring 33. In FIG. 15I, the resists 32 were etched using RIE to remove lower portions of the resists 32. In FIG. 15J, a metal film 35 was formed over the surface of the multilayer wiring substrate 31 using sputtering. In FIG. 15K, the resists 42 were removed using a known liftoff technique, to thereby obtain the multilayer wiring substrate 31 having the metal film 35 partially remaining on the surface of the substrate 31. In FIG. 15L, the remaining metal film 35 was subjected to nonelectrolytic plating. With the steps described above, the multilayer wiring substrate 31 having a metal wiring composed of the metal film 34 on its surface was obtained.

As described above, the present invention is applicable to a manufacture of the multilayer wiring substrate 31 which has a metal wiring with high dimensional precision.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

1. An imprint device comprising:
a stamper with a micropattern created thereon; and
a material to be transferred onto which the micropattern on the stamper is transferred,
the imprint device transferring the micropattern of the stamper onto the material to be transferred by bringing the stamper and the material to be transferred in contact with each other, and separating the stamper from the material to be transferred,
the stamper comprising: a surface with the micropattern; and a recessed part at least on a portion of an outer circumferential part around the surface with the micropattern, and
an outer diameter of the stamper being larger than an outer diameter of the material to be transferred, and the outer diameter of the material to be transferred being larger than an outer diameter of the surface with the micropattern.

2. The imprint device according to claim 1, wherein the outer diameter of the material to be transferred is larger than the outer diameter of the surface with the micropattern by 0.1 mm to 10 mm.

3. The imprint device according to claim 1, further comprising a plurality of retaining units provided on a stage for setting the material to be transferred,
the retaining units retaining an end belonging to the recessed part of the material to be transferred.

4. The imprint device according to claim 1, wherein the stamper is transparent.

5. A stamper with a micropattern created thereon comprising:
a surface with the micropattern; and
a recessed part at least on a portion of an outer circumferential part around the surface with the micropattern,
the stamper being brought into contact with a material to be transferred, transferring the micropattern thereof onto the material to be transferred, and being separated from the material to be transferred, and
an outer diameter of the stamper being larger than an outer diameter of the material to be transferred, and the outer diameter of the material to be transferred being larger than an outer diameter of the surface with the micropattern.

6. The stamper according to claim 5, wherein the outer diameter of the material to be transferred is larger than the outer diameter of the surface with the micropattern by 0.1 mm to 10 mm.

7. An imprint method comprising:
a contact step of bringing a stamper with a micropattern created thereon and a material to be transferred into contact with each other;
a transfer step of transferring the micropattern on the stamper onto a surface of the material to be transferred; and
a separating step of separating the stamper from the material to be transferred,
the stamper comprising: a surface with the micropattern; and a recessed part at least on a portion of an outer circumferential part around the surface with the micropattern, and
an outer diameter of the stamper being larger than an outer diameter of the material to be transferred, and the outer diameter of the material to be transferred being larger than an outer diameter of the surface with the micropattern.

8. The imprint method according to claim 7, further comprising a retaining step conducted prior to the separating step, the retaining step comprising retaining an end belonging to the recessed part of the material to be transferred, by a plurality of retaining units provided on a stage for setting the material to be transferred thereon.
